(19) United States
(12) Patent Application Publication
(10) Pub. No.: US 2004/0097354 A1
(43) Pub. Date: May 20, 2004

(54) Filter assembly for a cigarette and method of producing same

(76) Inventors: Yoichiro Yamashita, Tokyo (JP); Shichisei Tani, Tokyo (JP); Toshiaki Okuzama, Tokyo (JP)

Correspondence Address: BIRCH STEWART KOLASCH & BIRCH, PO BOX 747, FALLS CHURCH, VA, 22040-0747, US

(21) Appl. No.: 10/699,695

(22) Filed: Nov. 4, 2003

Related U.S. Application Data
(63) Continuation of application No. PCT/JP02/04674, filed on May 15, 2002.

(30) Foreign Application Priority Data
May 30, 2001 (JP) 2001-162884

(51) Int. Cl. B31C 13/00

(52) U.S. Cl. 493/39

(57) ABSTRACT

A filter assembly for a cigarette includes a cylindrical filter element. The filter element includes a filter material made of a bundle of acetate fibers, wrapping paper wound around the filter material, and an adhesive region formed on the inner surface of the wrapping paper, the adhesive region having a part applied with adhesive and continuously extending in the circumferential direction of the filter element. A method of producing the filter assemblies includes a process of applying adhesive to part of a paper web, which is the wrapping paper, to form the adhesive-applied part before the paper web reaches a wrapping section.

### TECHNICAL FIELD

The present invention relates to a filter assembly used as a filter tip of a filter cigarette to filtrate tobacco smoke from the cigarette, and a method of producing the filter assembly.

### BACKGROUND ART

A filter assembly for a cigarette usually includes a cylindrical plain filter element, which has a filter material made of acetate fibers and wrapping paper wound around the filter material. The wrapping paper has its both side edges lapped over each other with lap glue therebetween, thus forming a lap seam. Also, the wrapping paper is applied with rail glue that bonds the wrapping paper to the filter material.

More specifically, the rail glue is applied to the wrapping paper in the form of a line and extends straight in the axial direction of the plain filter element. The rail glue and the lap seam are separated from each other in a diametrical direction of the plain filter element.

A charcoal filter element is also often used in the filter assembly for a cigarette. The charcoal filter element has particles of activated charcoal distributed through a filter material made of acetate fibers.

This type of charcoal filter element is not used singly as a filter assembly for a cigarette; it is used in combination with a plain filter element to constitute a dual filter assembly for a cigarette.

Namely, the dual filter assembly includes plain and charcoal filter elements arranged adjacent to each other in alignment, and forming paper wound around the filter elements to connect the two to each other. Like the wrapping paper, both side edges of the forming paper form a lap seam, and the forming paper and the filter elements are bonded together by rail glue.

Regardless of whether the filter element applied with rail glue is a plain filter element or a dual filter element, the rail glue extends in a straight line along the axial direction of the filter element. Thus, in a circumferential region of the filter element except for the region where the rail glue exists, the wrapping paper and the filter material are merely in close contact with each other. This is also the case with the dual filter element. The forming paper and the wrapping paper are simply in close contact with each other in a region other than the region where the rail glue is applied.

During smoking of a filter cigarette, therefore, if the smoker repeatedly presses the filter assembly of the filter cigarette with the fingers or bites the filter assembly with the teeth, the filter assembly is liable to become deformed. Such deformation of the filter assembly creates a gap between the wrapping paper and the filter material or between the forming paper and the wrapping paper, with the result that main stream smoke from the cigarette is drawn directly into the smoker's mouth through the gap. As a consequence, the amounts of nicotine and tar actually flowing into the smoker's mouth become outside the specifications of the filter cigarette.

Also, the rail glue between the wrapping paper and the filter material and the rail glue between the forming paper and the wrapping paper are both applied in the form of a line, and thus the adhesive strength thereof is low. Consequently, during the manufacture of filter elements or filter cigarettes, the filter material or the plain or charcoal filter element may possibly slip out of the wrapping paper of the filter element or the forming paper of the dual filter assembly.

### OBJECT AND DISCLOSURE OF THE INVENTION

An object of the present invention is to provide a filter assembly for a cigarette whereby the amounts of nicotine and tar that the smoker inhales as main stream smoke can be accurately kept at levels meeting the specifications of the filter cigarette and also a filter material or filter element can be prevented from coming off in the process of manufacture of filter elements or filter cigarettes, and a method of producing the filter assembly.

A filter assembly according to the invention comprises a cylindrical filter element. The filter element includes a filter material, wrapping paper wound around the filter material, and an adhesive region provided between the wrapping paper and the filter material and bonding the wrapping paper and the filter material to each other, the adhesive region having a part applied with adhesive and continuously extending in a circumferential direction of the filter material.

In this filter assembly, the wrapping paper is bonded through the adhesive-applied part to the filter material over an entire circumference thereof. Accordingly, even if the filter assembly is repeatedly pressed with the fingers or is bitten with the teeth to an extent such that a gap is formed between the wrapping paper and the filter material, such a gap never extends in the axial direction of the filter assembly throughout the assembly. In consequence, where the filter assembly of the present invention is used in a filter cigarette, all of the main stream smoke that the smoker inhales from the cigarette is the smoke which has passed through the filter assembly, whereby the amounts of nicotine and tar that the smoker takes in can be stably kept at levels meeting the specifications of the filter cigarette.

The adhesive region may include a plurality of adhesive-applied parts arranged at intervals in the axial direction of the filter element. Specifically, the adhesive-applied parts may constitute a continuous loop pattern having loops arranged in a longitudinal direction of the wrapping paper, or a meandering pattern extending in the longitudinal direction of the wrapping paper, or a bar pattern having bars arranged at intervals in the longitudinal direction of the wrapping paper, as viewed in development of the wrapping paper.

Whichever pattern the adhesive-applied parts may have, the wrapping paper is bonded to the filter material over the entire circumference of the filter element such that the former is bonded to the latter at intervals in the axial direction of the filter element. The adhesive region like this ensures high adhesiveness between the wrapping paper and the filter material, making it possible to prevent the filter material from slipping out of the wrapping paper. Also, none of the aforementioned patterns significantly lower the air permeability of the wrapping paper.

The filter material comprises a bundle of fibers such as acetate fibers, and in this case, the filter material may include particles of adsorbent, such as activated charcoal, distributed therein. Where the aforementioned bar pattern is applied to such a filter element including adsorbent particles, the adhesive bars are preferably located so as to coincide with at least one end of the filter material, in which case the adhesive bars prevent the adsorbent particles from escaping from the filter element.

The adhesive-applied part may alternatively extend over an entire outer peripheral surface of the filter material.

Where the filter element is a plain filter element whose filter material is made of a fiber bundle only, the filter assembly may further comprise a cylindrical charcoal filter element arranged adjacent to the plain filter element.

The charcoal filter element includes a filter material made of a bundle of fibers, particles of adsorbent distributed through the filter material, wrapping paper wound around the filter material, an inner adhesive region provided between the filter material and the wrapping paper and bonding the wrapping paper and the filter material to each other, the inner adhesive region having a part applied with adhesive and continuously extending in a circumferential direction of the filter material, forming paper wound around the plain and charcoal filter elements to connect the filter elements to each other, and an outer adhesive region provided between the forming paper and the filter elements and bonding the forming paper to the filter elements, the outer adhesive region having a part applied with adhesive and continuously extending in a circumferential direction of the filter elements.

The filter assembly constructed in this manner is a dual filter assembly having high additional functionality.

The filter assembly is produced by a method according to the present invention. The production method comprises the steps of: supplying a rod-like filter member and a paper web to a wrapping section; continuously wrapping the filter member in the paper web when the filter member and the paper web pass through the wrapping section, to form a filter rod; and cutting the filter rod into filter plugs of predetermined length. The paper web supply step includes a process of forming an adhesive region for bonding the paper web and the filter member to each other, and the process includes applying adhesive to a part of the paper web before the paper web reaches the wrapping section, the adhesive-applied part being continuous in a width direction of the paper web.

The adhesive-applied part may constitute any one of the aforementioned various patterns.

Where the filter member is made of a bundle of fibers, the filter member supply step may further include a process of distributing particles of adsorbent through the fiber bundle before the fiber bundle reaches the wrapping section. In this case, filter assemblies including adsorbent particles are obtained.

Further, where the filter member comprises a rod member having plain and charcoal filter plugs alternately arranged in series and wrapped together in forming paper, each plain filter plug has a filter material and wrapping paper wound around the filter material, and each charcoal filter plug has a filter material, particles of activated charcoal distributed through the filter material and wrapping paper wound around the filter material, the aforementioned dual filter assemblies are produced by the production method.

### BRIEF DESCRIPTION OF THE DRAWINGS

FIG. 1 is a partly broken perspective view of a filter cigarette;

FIG. 2 is an end view of a filter tip of the filter cigarette shown in FIG. 1;

FIG. 3 is a perspective view showing an inner surface of wrapping paper;

FIG. 4 is a schematic diagram showing a filter rod manufacturing machine;

FIG. 5 is a longitudinal sectional view of a lap glue applicator;

FIG. 6 is a longitudinal sectional view of an adhesive applicator;

FIG. 7 is a view showing an application pattern of adhesive formed on an inner surface of a paper web with the use of the applicator shown in FIG. 6;

FIG. 8 is a perspective view of a plain filter plug produced by the manufacturing machine shown in FIG. 4;

FIG. 9 is a perspective view of a charcoal filter plug produced by a manufacturing machine similar to that shown in FIG. 4;

FIG. 10 is a schematic diagram showing a dual filter plug manufacturing machine;

FIG. 11 is a diagram illustrating how a row of double plain elements and double charcoal elements is formed by the manufacturing machine shown in FIG. 10;

FIG. 12 is a diagram showing an internal arrangement of a dual filter plug;

FIGS. 13 and 14 illustrate other application patterns of adhesive;

FIG. 15 is a view showing a spray gun used to obtain the application pattern shown in FIG. 14;

FIG. 16 illustrates still another application pattern of adhesive;

FIG. 17 is a diagram showing a transfer-type applicator used to form the application pattern shown in FIG. 16;

FIG. 18 is a partly broken perspective view showing a modification of the filter cigarette; and

FIG. 19 is a partly broken perspective view showing another modification of the filter cigarette.

### BEST MODE OF CARRYING OUT THE INVENTION

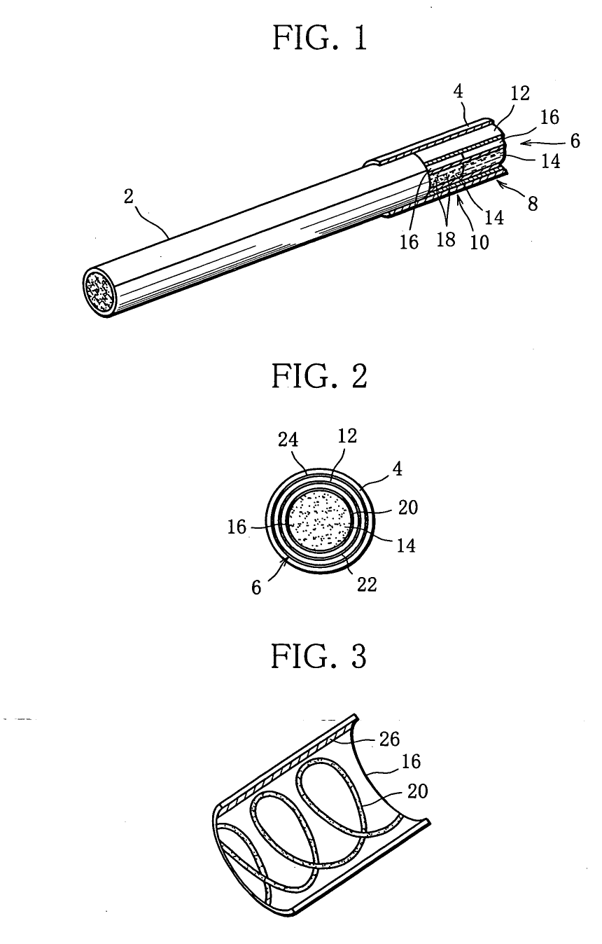

FIG. 1 illustrates a filter cigarette.

The filter cigarette includes a cigarette 2 and a filter tip. The filter tip has a dual filter assembly 6 adjoining one end of the cigarette 2 and tip paper 4 connecting the dual filter assembly 6 to the cigarette 2. The tip paper 4 is wound so as to cover the dual filter assembly 6 as well as the end portion of the cigarette 2, and thus the tip paper overlaps with wrapping paper of the cigarette 2.

In this embodiment, the dual filter assembly 6 includes a plain filter element 8 and a charcoal filter element 10 which is an additional filter element with a function other than the function of filtrating main stream smoke of the cigarette. The filter elements 8 and 10 are connected to each other by forming paper 12 wound around these elements. The charcoal filter element 10 is located between the cigarette 2 and the plain filter element 8.

The plain filter element 8 has a filter material 14 made of fibers such as acetate fibers, and wrapping paper 16 wrapping the filter material 14 into a cylindrical form. Both side edges of the wrapping paper 16 are lapped one over the other with lap glue therebetween and thus are bonded to each other, forming a lap seam.

The charcoal filter element 10 includes a filter material 14 and wrapping paper 16 similar to the counterparts of the plain filter element 8, but differs from the plain filter element 8 in that particles 18 of activated charcoal serving as an adsorbent are included in the filter material 14. The particles 18 are distributed uniformly through the filter material 14.

As is clear from FIG. 2, the filter material 14 is wound with the wrapping paper 16, the forming paper 12 and the tip paper 4, and thus the wrapper for the filter material 14 as a whole has a three-layer structure.

The wrapping paper 16 for the filter elements 8 and 10 has an adhesive region 20 on an inner surface thereof and is bonded through the adhesive region 20 to a peripheral surface of the filter material 14. Also, the forming paper 12 has an adhesive region 22 on an inner surface thereof and is bonded through the adhesive region 22 to an outer surface of the wrapping paper 16 of the filter elements 8 and 10. Further, the tip paper 4 also has an adhesive region 24 on an inner surface thereof and is bonded through the adhesive region 24 to an outer surface of the forming paper 12.

As shown in FIG. 3, the adhesive region 20 is formed by applying adhesive to the inner surface of the wrapping paper 16 according to a continuous loop pattern. More specifically, the adhesive region 20 has loops of adhesive arranged at predetermined intervals in a longitudinal direction of the wrapping paper 16, and each loop has a size covering the entire width of the wrapping paper 16 except the both side edges thereof. FIG. 3 also shows the aforementioned lap glue 26 applied in the form of a line.

Like the adhesive region 20, the adhesive region 22 of the forming paper 12 is also formed by applying adhesive to the inner surface thereof. The adhesive region 24 of the tip paper 4 is formed by applying adhesive to part or the entire inner surface of the tip paper 4.

The wrapping paper 16 of the filter element 8, 10 is bonded to the peripheral surface of the corresponding filter material 14 through the adhesive region 20 having a loop pattern as mentioned above. Accordingly, with respect to at least the circumferential direction of the filter material 14, the wrapping paper 16 is bonded to the peripheral surface of the filter material 14 over substantially the entire circumference thereof. Thus, even if the dual filter assembly 6 is deformed as mentioned above during smoking of the filter cigarette to such an extent that a gap is formed between the wrapping paper 16 and the filter material 14, the gap does not extend throughout the filter element 8 or 10 in the axial direction thereof but axial extension thereof is obstructed by the adhesive lines forming the loops.

Consequently, the main stream smoke from the cigarette 2 passes through the filter materials 14 of the charcoal and plain filter elements 10 and 8 without fail before entering the smoker's mouth, whereby the amounts of nicotine and tar in the main stream smoke that the smoker takes in can be accurately kept at levels meeting the specifications of the filter cigarette.

The adhesive region 20 having the loop pattern secures a large bonding area between the filter material 14 and the wrapping paper 16, compared with the straight-line rail glue. Since the adhesion between the filter material 14 and the wrapping paper 16 is enhanced, the filter material 14 does not slip out of the wrapping paper 16 in the process of manufacture of the dual filter assemblies 6 or filter cigarettes or after the manufacture of filter cigarettes, thus eliminating defects in the filter tips of filter cigarettes.

The filter material 14 of the charcoal filter element 10 contains activated charcoal particles 18, and thus some of the particles 18 are exposed on the outer surface of the filter material 14. Such exposed particles 18 between the filter material 14 and the wrapping paper 16 may possibly enter the clearance between the filter material 14 and wrapping paper 16 of the filter element 8 and move in the axial direction of the filter element 8 to the outer end face of the element 8. Because of the adhesive regions 20 of the filter elements 8 and 10, however, such movement of the activated charcoal particles 18 can be prevented without fail.

Further, since each adhesive region 20 does not extend over the entire inner surface of the wrapping paper 16, there arises no significant drop in the air permeability of the wrapping paper 16.

The forming paper 12 is also bonded to the filter elements 8 and 10 through the adhesive region 22 similar to the adhesive regions 20. Accordingly, even if a gap is formed between the forming paper 12 and the filter element 8 or 10, the gap never extends throughout the filter element 8 or 10 in the axial direction thereof. The amounts of nicotine and tar in the main stream smoke that the smoker takes in can therefore be kept at levels meeting the specifications of the filter cigarette. Further, since the adhesive region 22 does not extend over the entire surface of the forming paper 12, the forming paper 12 maintains sufficient air permeability.

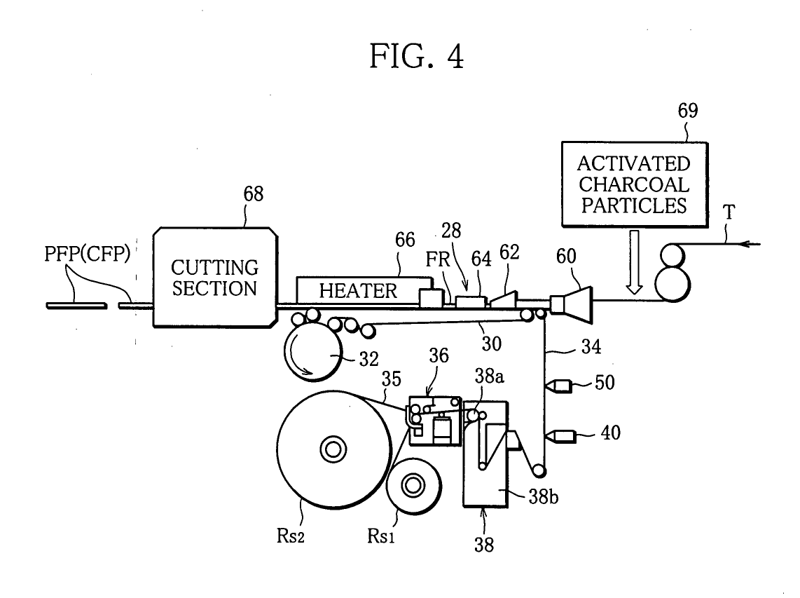

The plain filter element 8 is obtained by cutting a plain filter plug which is a plurality of times as long as the element 8. The plain filter plug is produced by a rod manufacturing machine shown in FIG. 4.

The manufacturing machine has a wrapping section 28 similar to that of a cigarette rod manufacturing machine. The wrapping section 28 has an endless garniture tape 30 which is adapted to pass through a forming bed (not shown) of the wrapping section 28. More specifically, the garniture tape 30 horizontally extends inside a forming groove of the forming bed and is passed around a driving drum 32. As the driving drum 32 rotates, the garniture tape 30 travels inside the forming groove in one direction from an inlet of the forming bed toward an outlet thereof.

At the inlet of the forming bed, a paper web 34, which is the wrapping paper 16, is superposed on the garniture tape 30, and thus the paper web 34 thereafter travels together with the garniture tape 30 and passes inside the forming groove of the forming bed. Specifically, the paper web 34 is delivered from a web roll R_{S1} and guided to the forming bed along a predetermined delivery path. Along the delivery path are arranged a connection device 36, a reservoir device 38, a lap glue applicator 40 and an adhesive applicator 50 in the order mentioned from the side of the web roll R_{S1}.

When the remainder of the web roll R_{S1} becomes small and the paper web 34 runs short, the reservoir device 38 operates first. A pulling roller 38a of the reservoir device 38 unrolls the paper web 34 from the web roll R_{S1} at a speed higher than the traveling speed of the garniture tape 30, to store a predetermined amount of the paper web 34 in a reservoir chamber 38b, and then the rotation of the pulling roller 38a, that is, the delivery of the paper web 34 from the web roll R_{S1}, is stopped.

Subsequently, the connection device 36 connects a paper web 35 guided thereto from a standby web roll R_{S2} to the paper web 34 of the web roll R_{S1}. The connection device 36 then cuts the paper web 34 at a location upstream the joint of the webs 34 and 35 and also cuts the paper web 35 at a location downstream the joint, thereby completing the web connection. During the web connection, the paper web 34 stored in the reservoir chamber 38b is supplied to the wrapping section 28.

After the web connection is completed, the pulling roller 38a of the reservoir device 38 is rotated at a peripheral speed corresponding to the traveling speed of the garniture tape 30, to unroll the paper web 35 from the web roll R_{S2}. In consequence, the paper web supply is switched from the web roll R_{S1} to the web roll R_{S2}.

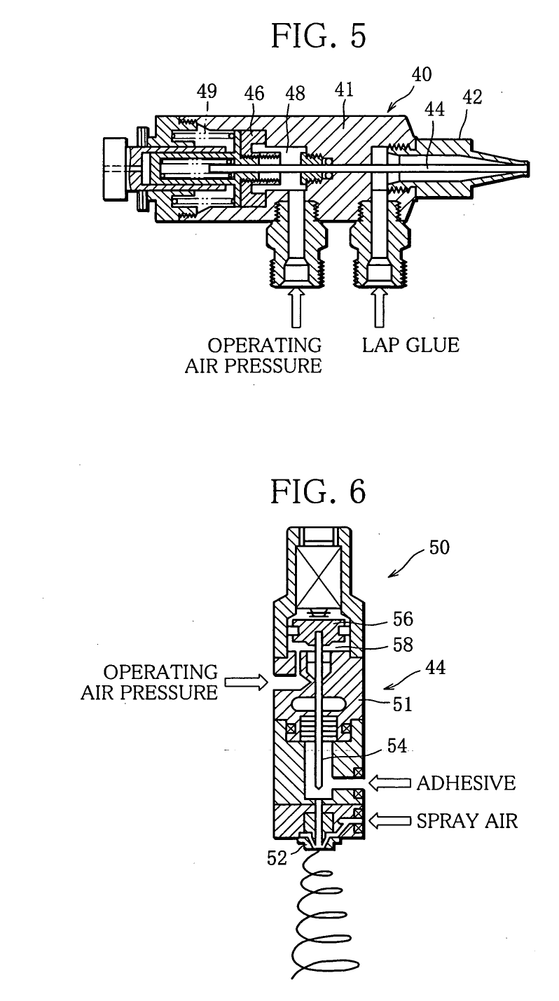

The lap glue applicator 40 is shown in FIG. 5.

The applicator 40 has a nozzle body 41 having a nozzle 42 at one end thereof. Lap glue is supplied to the interior of the nozzle 42 through the nozzle body 41, and when a needle valve 44 in the nozzle 42 is lifted, the lap glue is discharged from the nozzle 42 toward the paper web 34 in a straight line. As a result, the lap glue is continuously applied to one side edge of the traveling paper web 34, thus forming the glue-applied line 26 shown in FIG. 3.

More specifically, a piston 46 is arranged in the nozzle body 41 and defines a pressure chamber 48 within the body 41. The piston 46 is coupled to the needle valve 44 and is urged by a valve spring 49 toward the pressure chamber 48, that is, in the direction of closing the needle valve 44.

When the pressure chamber 48 is supplied with an operating air pressure, the air pressure lifts the needle valve 44 through the piston 46 against the urging force of the valve spring 49. Preferred lap glue includes a vinyl acetate-based glue.

The adhesive applicator 50 is shown in FIG. 6.

This applicator 50 also has a nozzle body 51 having a nozzle 52 at one end thereof. The nozzle 52 is supplied with adhesive through the nozzle body 51 and is opened and closed by a needle valve 54. The needle valve 54 is coupled to a piston 56, and when an operating air pressure is supplied to a pressure chamber 58, the needle valve 54 lifts against the urging force of a valve spring (not shown), thereby opening the nozzle 52 to allow the adhesive to be discharged toward the traveling paper web 34.

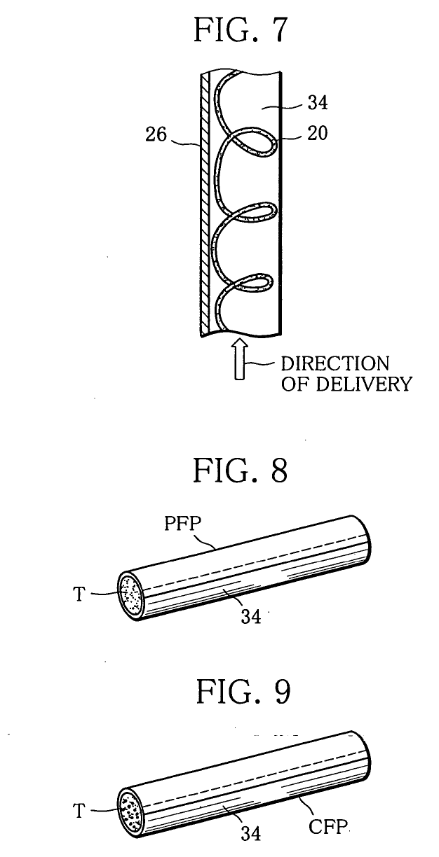

The nozzle 52 is supplied further with spray air, and the spray air is spirally ejected from around a nozzle hole of the nozzle 52. The spirally ejected air causes the adhesive discharged from the nozzle 52 to turn spirally. As a result, the adhesive is applied to the inner surface of the paper web 34 while forming the aforementioned loop pattern, as shown in FIG. 7, whereby the adhesive region 20 is formed. For the adhesive, a vinyl acetate-based glue is also used.

As shown in FIG. 4, a trumpet guide 60 is arranged at the inlet of the forming bed, and a band of tow T of acetate fibers is introduced into the trumpet guide 60. The tow T is formed into a rod while passing through the trumpet guide 60 and is fed onto a central portion of the paper web 34. Since the web 34 has the adhesive region 20 formed on its inner surface, the rod-shaped tow T adheres to the paper web 34 through part of the adhesive region 20. Thus, the tow T travels in one direction together with the paper web 34.

Subsequently, the rod-shaped tow T passes through a tongue 62 on the forming bed together with the paper web 34. At this time, the tongue 62 compresses the tow T into a shape such that the tow T has a circular cross-sectional form. On the other hand, the paper web 34 is curved into a U-shape, as viewed in section, by the forming groove of the forming bed through the garniture tape 30, so as to wrap the rod-shaped tow T from below.

The rod-shaped tow T and the paper web 34 then pass through a former 64. At this time, first, one side edge portion of the web 34 is arcuately curved so as to cover one side of the upper half of the rod-shaped tow T. Subsequently, the other side edge portion of the paper web 34 is also arcuately curved so as to cover the other side of the upper half of the rod-shaped tow T. Thus, as the rod-shaped tow T passes through the former 64, the tow T is continuously wrapped in the paper web 34 to form a filter rod FR. In this case, both side edges of the paper web 34 are lapped one over the other with the lap glue-applied line 26 therebetween and thus are bonded together, forming a lap seam.

Subsequently, the filter rod FR passes through a heater 66 and a cutting section 68 in this order. The heater 66 dries the lap seam of the filter rod FR, and the cutting section 68 cuts the filter rod FR into parts with a predetermined length. As a result, a plain filter plug PFP as shown in FIG. 8 is obtained.

The aforementioned plain filter element 8 is obtained by cutting the plain filter plug PFP into parts with a given length. Accordingly, the plain filter plug PFP has a length a plurality of times as large as that of the plain filter element 8.

The charcoal filter element 10 is also obtained by cutting a charcoal filter plug CFP produced by a manufacturing machine similar to that shown in FIG. 4. The manufacturing machine for producing the charcoal filter plugs CFP further includes a spreader 69, as shown in FIG. 4, and the spreader 69 sprinkles particles of activated charcoal uniformly over the tow T on the upstream side of the trumpet guide 60. Consequently, the charcoal filter plug CFP obtained after passing through the cutting section 68 has activated charcoal particles included in the tow T.

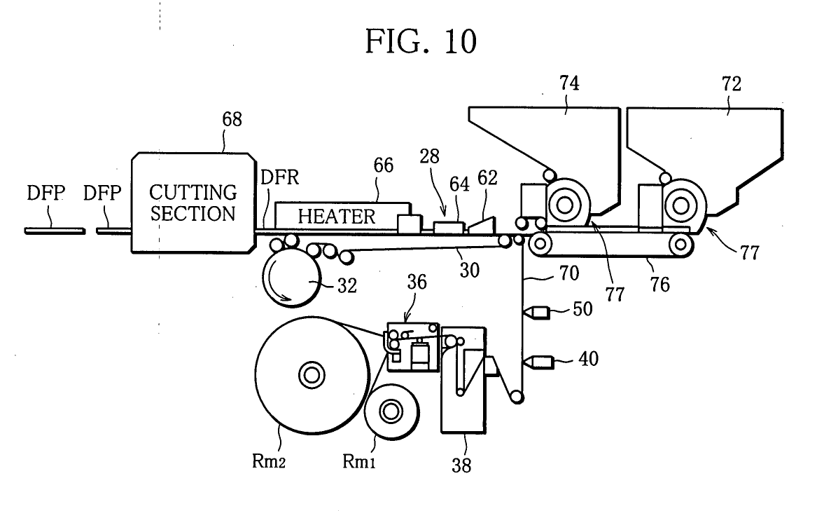

The aforementioned dual filter assembly 6 is produced by a manufacturing machine for combining the plain and charcoal filter plugs PFP and CFP. The manufacturing machine is shown in FIG. 10.

The manufacturing machine shown in FIG. 10 is similar to that shown in FIG. 4 in that it has parts equivalent to the wrapping section 28, the cutting section 68, etc. appearing in FIG. 4. In FIG. 10, therefore, identical reference numerals are used to denote parts having the same functions as those in the manufacturing machine of FIG. 4 for simplicity of explanation.

The manufacturing machine of FIG. 10 differs from that shown in FIG. 4 in the following respects:

The wrapping section 28 in FIG. 10 is supplied with a paper web 70 which is the forming paper 12. The paper web 70 is delivered from a web roll Rₘ₁. When the paper web 70 passes the applicators 40 and 50, a lap glue line and the adhesive region 22, similar to the adhesive region 20, are successively formed on the inner surface of the paper web 70. In the figure, Rₘ₂ represents a standby web roll.

A pair of hoppers 72 and 74 are arranged in a line on the upstream side of the wrapping section 28 and respectively store the plain filter plugs PFP and the charcoal filter plugs CFP.

An assembly conveyor 76 is arranged below the hoppers 72 and 74. The assembly conveyor 76 extends toward the wrapping section 28 and connects with the inlet of the forming bed.

A dispenser 77 is arranged between the hopper 72 and the assembly conveyor 76, and takes out the plugs PFP one by one from the hopper 72. The plug PFP thus taken out is cut into a plurality of double plain elements 8_{D} of equal length. The length of the double plain element 8_{D} is twice that of the plain filter element 8. The dispenser 77 then feeds the individual double plain elements8_{D} onto the assembly conveyor 76.

Also, a dispenser 77 is arranged between the hopper 74 and the assembly conveyor 76 and feeds double charcoal elements 10_{D} onto the assembly conveyor 76. The double charcoal elements 10_{D} are obtained by cutting the charcoal filter plug CFP into a plurality of equal parts and each have a length twice that of the charcoal filter element 10.

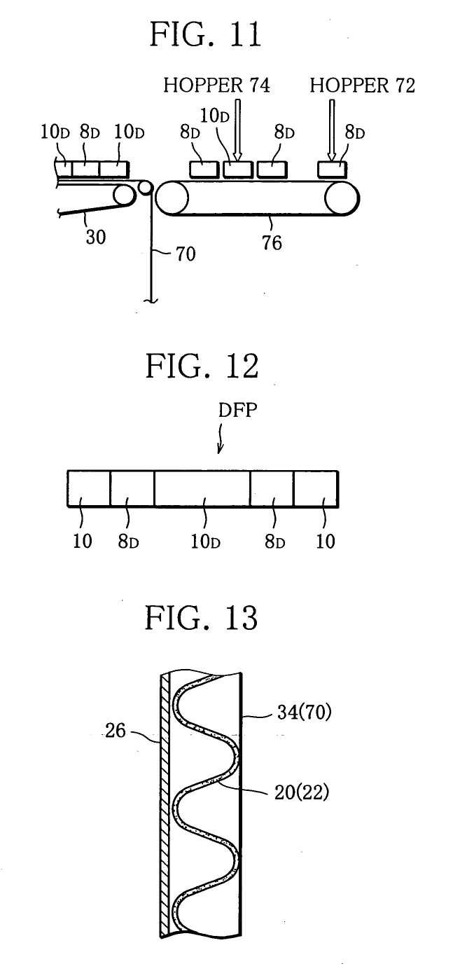

As shown in FIG. 11, the double plain elements 8_{D} and the double charcoal elements 10_{D} are fed onto the assembly conveyor 76 in such a manner that the elements 8_{D} and 10_{D} are alternated in the transporting direction of the assembly conveyor 76. Subsequently, the elements 8_{D} and 10_{D} are brought into close contact with each other on the assembly conveyor 76 to form a rod-like row, which is then supplied to the wrapping section 28.

Accordingly, as the row of elements passes through the wrapping section 28 together with the paper web 70, it is continuously wrapped in the paper web 70, thus forming a dual filter rod DFR. Then, in the cutting section 68, the dual filter rod DFR is cut into individual dual filter plugs DFP. Each dual filter plug DFP includes four dual filter assemblies 6. Specifically, the dual filter plug DFP is obtained by cutting the dual filter rod DFR in the center of every other double charcoal element 10_{D}, as shown in FIG. 12.

The dual filter plugs DFP produced in this manner are supplied to a hopper of a filter attachment apparatus (not shown) directly connected to a cigarette manufacturing machine. The filter attachment apparatus cuts each of the dual filter plugs DFP taken out of the hopper into two equal parts, that is, two double dual filter assemblies. Each double dual filter assembly is then supplied and positioned between two cigarettes, and the two cigarettes with the double dual filter assembly therebetween are connected together by tip paper, thus forming a double filter cigarette. Subsequently, the double filter cigarette is cut in the center of the double dual filter assembly, thereby obtaining filter cigarettes as shown in FIG. 1.

The present invention is not limited to the foregoing embodiment and may be modified in various ways.

For example, the pattern of the adhesive regions 20 and 22 formed on the paper webs 34 and 70 is not limited to the aforementioned loop pattern and may be a meandering pattern as shown in FIG. 13.

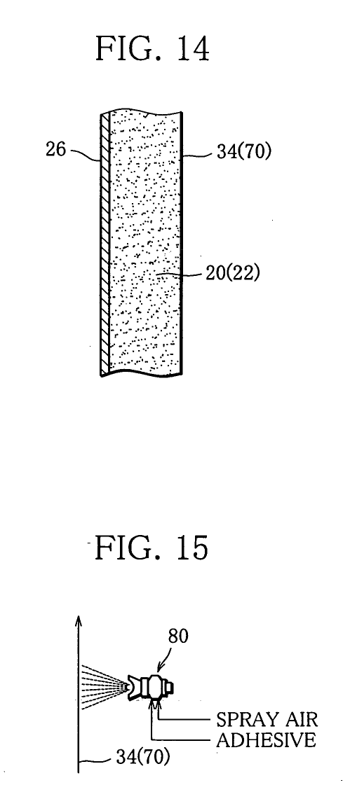

Also, as shown in FIG. 14, the adhesive regions 20 and 22 may each be formed over the entire inner surface of the web except for the glue-applied line 26. In this case, the adhesive is sprayed from a spray gun 80 toward the paper web 34 or 70, as shown in FIG. 15.

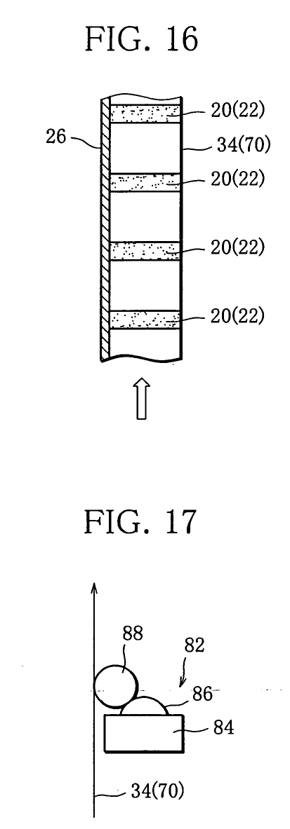

Further, as shown in FIG. 16, the adhesive regions 20 and 22 may each have a bar pattern which includes bars of adhesive formed intermittently or at intervals in the direction of delivery of the paper web 34, 70 and extending in the width direction of the paper web. The adhesive region having such a bar pattern is formed using a transfer-type applicator 82 shown in FIG. 17. The applicator 82 has a glue roller 86 arranged in a glue pod 84, and a transfer roller 88 disposed in rolling contact with the glue roller 86. The glue or adhesive is transferred from the transfer roller 88 intermittently or at intervals to the paper web.

Also, the patterns of the adhesive regions 20 and 22 may not be the same and the regions 20 and 22 may have different patterns.

Where the wrapping paper 16 for the charcoal filter element 10 is applied with the adhesive region 20 having the bar pattern shown in FIG. 16, the adhesive region 20 is preferably located such that one adhesive bar or band thereof coincides with one end of the charcoal filter element 10, or more specifically, with that end of the charcoal filter element which adjoins the plain filter element 8 of the dual filter assembly 6. In this case, even if particles of activated charcoal are exposed on the outer surface of the corresponding end portion of the filter material 14, the exposed particles are held on the outer surface of the filter material 14 by the adhesive band and do not move toward the plain filter element 8. The adhesive region may also be formed such that adhesive bands thereof are located respectively at the opposite ends of the charcoal filter element 10.

Also, the lap glue line 26 may be applied after the adhesive region 20, 22 is formed on the inner surface of the paper web 34, 70.

In the case where hot melt, instead of vinyl acetate-based glue, is used as the lap glue, the manufacturing machines shown in FIGS. 4 and 10 individually have a cooler (not shown) arranged on the downstream side of the heater 66 to cool the lap seam of the filter rod.

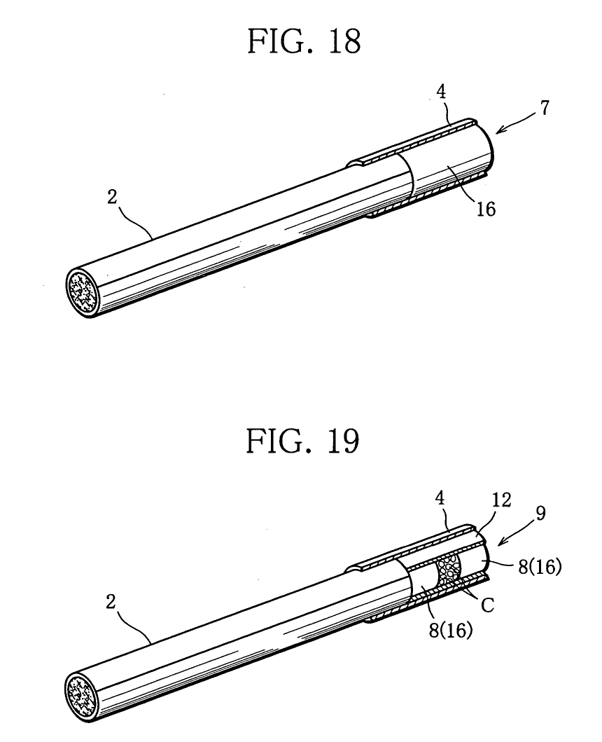

The filter assembly for a cigarette according to the present invention is not limited to the dual filter assembly 6 and may be a single filter assembly 7 as shown in FIG. 18. The single filter assembly 7 includes the plain filter element 8 only. Also in this filter element 8, the wrapping paper 16 and the filter material 14 are bonded to each other through the adhesive region 20.

Further, the filter assembly for a cigarette according to the present invention may be a triple filter assembly 9 as shown in FIG. 19. The triple filter assembly 9 includes the plain filter elements 8 arranged at opposite ends thereof and particles C of activated charcoal filled in the space between the filter elements 8.

In the triple filter assembly 9 shown in FIG. 19, the plain filter element 8 adjoining the cigarette 2 may be replaced with the charcoal filter element 10, or the activated charcoal particles between the filter elements 8 may be replaced with the charcoal filter element 10. The triple filter assembly may be modified in various other ways insofar as the plain filter element 8 constitutes at least the tip of the assembly where the smoker's mouth touches.

Further, although in the foregoing embodiment particles of activated charcoal are used as the adsorbent, other adsorbents such as particles of silica gel may be used instead. It is also possible to use particles of aromatic etc. so that the filter assembly may have additional functions.

1. A filter assembly for a cigarette, comprising:
a cylindrical filter element, said filter element including
a filter material,
wrapping paper wound around the filter material, and
an adhesive region provided between the wrapping paper and the filter material and bonding the wrapping paper and the filter material to each other, the adhesive region having a part applied with adhesive and continuously extending in a circumferential direction of the filter material.

2. The filter assembly according to claim 1, wherein the adhesive region has a plurality of adhesive-applied parts arranged at intervals in an axial direction of the filter element.

3. The filter assembly according to claim 2, wherein the adhesive-applied parts constitute a continuous loop pattern having loops arranged in a longitudinal direction of the wrapping paper, as viewed in development of the wrapping paper.

4. The filter assembly according to claim 2, wherein the adhesive-applied parts constitute a meandering pattern extending in a longitudinal direction of the wrapping paper, as viewed in development of the wrapping paper.

5. The filter assembly according to claim 2, wherein the adhesive-applied parts constitute a bar pattern having bars arranged at intervals in a longitudinal direction of the wrapping paper, as viewed in development of the wrapping paper.

6. The filter assembly according to claim 2, wherein the filter material comprises a bundle of fibers.

7. The filter assembly according to claim 6, wherein the filter element further includes particles of adsorbent distributed through the filter material.

8. The filter assembly according to claim 7, wherein the adhesive-applied parts constitute a bar pattern having bars arranged at intervals in a longitudinal direction of the wrapping paper, as viewed in development of the wrapping paper, and
one of the bars is located at one end of the filter material.

9. The filter assembly according to claim 1, wherein the adhesive-applied part extends over an entire outer peripheral surface of the filter material.

10. The filter assembly according to claim 1, wherein the filter element is a plain filter element whose filter material is made of a fiber bundle only,
the filter assembly further comprises a cylindrical charcoal filter element arranged adjacent to the plain filter element,
the charcoal filter element including
a filter material made of a bundle of fibers,
particles of adsorbent distributed through the filter material,
wrapping paper wound around the filter material,
an inner adhesive region provided between the filter material and the wrapping paper and bonding the wrapping paper and the filter material to each other, the inner adhesive region having a part applied with adhesive and continuously extending in a circumferential direction of the filter material,
forming paper wound around the plain and charcoal filter elements to connect the filter elements to each other, and
an outer adhesive region provided between the forming paper and the filter elements and bonding the forming paper to the filter elements, the outer adhesive region having a part applied with adhesive and continuously extending in a circumferential direction of the filter elements.

11. A method of producing filter assemblies for cigarettes, comprising the steps of:
supplying a rod-like filter member and a paper web to a wrapping section;
continuously wrapping the filter member in the paper web when the filter member and the paper web pass through the wrapping section, to form a filter rod; and
cutting the filter rod into filter plugs of predetermined length,
wherein the paper web supply step includes a process of forming an adhesive region for bonding the paper web and the filter member to each other, the process including applying adhesive to a part of the paper web before the paper web reaches the wrapping section, the adhesive-applied part being continuous in a width direction of the paper web.

12. The method according to claim 11, wherein the adhesive-applied part is formed at intervals in a longitudinal direction of the paper web.

13. The method according to claim 12, wherein the adhesive-applied part constitutes a continuous loop pattern having loops arranged in the longitudinal direction of the paper web.

14. The method according to claim 12, wherein the adhesive-applied part constitutes a meandering pattern extending in the longitudinal direction of the paper web.

15. The method according to claim 12, wherein the adhesive-applied part constitutes a bar pattern having bars arranged at intervals in the longitudinal direction of the paper web.

16. The method according to claim 12, wherein the filter member comprises a bundle of fibers.

17. The method according to claim 16, wherein the filter member supply step further includes a process of distributing particles of adsorbent into the fiber bundle before the fiber bundle reaches the wrapping section.

18. The method according to claim 17, wherein the adhesive-applied part constitutes a bar pattern having bars arranged at intervals in the longitudinal direction of the paper web, and
one of the bars is located at one end of the filter member.

19. The method according to claim 11, wherein the adhesive-applied part extends over an entire area of the paper web except for a lap glue-applied line for bonding both side edges of the paper web to each other.

20. The method according to claim 11, wherein the filter member comprises a rod member having plain and charcoal filter plugs alternately arranged in series and wrapped together in forming paper,
each of the plain filter plugs has a filter material and wrapping paper wound around the filter material, and
each of the charcoal filter plugs has a filter material, particles of activated charcoal distributed through the filter material and wrapping paper wound around the filter material.
